(19) United States
(12) Patent Application Publication
(10) Pub. No.: US 2008/0167739 A1
(43) Pub. Date: Jul. 10, 2008

(54) Autonomous robot for music playing and related method

(75) Inventors: Chyi-Yeu Lin, Taipei (TW); Kuo-Liang Chung, Taipei (TW); Hung-Yan Gu, Keelung City (TW); Chin-Shyurng Fahn, Taipei (TW)

Correspondence Address: BIRCH STEWART KOLASCH & BIRCH, PO BOX 747, FALLS CHURCH, VA, 22040-0747, US

(73) Assignee: National Taiwan University of Science and Technology

(21) Appl. No.: 11/649,802

(22) Filed: Jan. 5, 2007

(51) Int. Cl. G06F 17/00; G06K 9/00; G05B 19/04

(52) U.S. Cl. 700/94; 84/487; 704/211; 700/246; 382/183; 901/2

(57) ABSTRACT

An autonomous robot mainly contains an image capturing device, an interpretation device, a synthesis device, and an audio output device. The image capturing device captures pages of graphical images in which appropriate musical information is embedded, and the interpretation device deciphers and recognizes the musical information contained in the captured graphical image. The synthesis device simulates the sound effects of a type of instrument or a human singer by synthesis techniques in accordance with the recognized musical information. The audio output device turns the output of the synthesis device into human audible sounds. The graphical image of appropriate musical information is prepared in a visually recognizable form. The graphical image can also contain special symbols to give instructions to the autonomous robot such as specifying an instrument.

### BACKGROUND OF THE INVENTION

1. Field of the Invention

The present invention generally relates to autonomous robots, and more particularly to a robotic device and a related method capable of recognizing graphical images with embedded musical information and delivering musical sounds in accordance with the musical information.

2. The Prior Arts

Recent researches have made significant progresses in making a robotic device to independently respond to external visual and/or audio stimulus without human involvement. Many academic and commercial prototypes have been disclosed on regular basis. To mention just a few, for example, the Sony® AIBO® is an autonomous robotic dog equipped with a camera for receiving graphical images on pictorial cards presented to it. The graphical image contains encoded instructions to trigger the robotic dog to change specific settings or to perform specific actions (e.g., dancing and singing).

Other examples include the DJ robots and music playing robots from Toyota®. The DJ robot is an autonomous robot on rolling wheels that can communicate with people and behaves like it is conducting a band of music playing robots. Each of the music playing robots, either with legs or on rolling wheels, can physically play an instrument such as trumpet, tuba, trombone, and drums. The music playing robots are not really autonomous ones, but are programmed to demonstrate their agility of arms, hands and fingers.

Yet another example is the Haile robot currently developed by the Georgia Institute of Technology, U.S.A. Haile is a robotic “drummer” that can listen to live players, analyze their music in real-time, and use the analytical result to play back on drums in an improvisational manner. The improvisatory algorithm enables the robot to respond to the playing of another live player. The robot can simply imitate what the other player is playing, or it can also transform its response or accompany the live player. A user can also compose music for the robot by feeding it a standard MIDI file.

Despite still quite primitive, these music playing robots are found to be quite useful for educational and entertainment purposes. However, most of these robots are designed to physically operate and play a single type of instrument and, in some cases, the instrument has to be tailored for the robot's operation. On the other hand, the rhythms delivered by the robots are mostly pre-programmed in the robots or, as in the Haile robot, are learned by the robots in advance from live players. In other words, these robots cannot change what they are playing on demand, but requires some preliminary work in preparing the robots. All these, in one way or another, limit the applicability of the music playing robots.

### SUMMARY OF THE INVENTION

Accordingly, a novel autonomous robot for music playing and a related method are provided herein which combine optical recognition and sound synthesis techniques in delivering highly flexible and dynamic music performance.

The autonomous robot mainly contains an image capturing device, an interpretation device, a synthesis device, and an audio output device. Usually these devices are housed in a humanoid or appropriate body. The image capturing device such as a CCD camera captures pages of graphical images in which appropriate musical information is embedded, and the interpretation device recognizes and deciphers the musical information contained in the captured graphical images. The synthesis device simulates the sound effects of at least a type of instrument or a human singer by synthesis techniques in accordance with the recognized musical information. The audio output device such as a loudspeaker turns the output of the synthesis device into human audible sounds. The audio output device is usually an integral part of the autonomous robot body, or it can be placed at a distance by appropriate signal cabling.

The autonomous robot operates in a trigger-and-response manner. The graphical images of appropriate musical information such as notes on a staff or numbered notations are prepared in a visually recognizable form such as printing or writing on a board or a piece of paper. The graphical images can also contain special symbols to give instructions to the autonomous robot such as specifying a specific type of instrument. The graphical images are then presented to the image capturing device of the autonomous robot to trigger its performance as instructed by the graphical images. A series of graphical images can be sequentially presented to the autonomous robot by a human user or the autonomous robot further contains a mechanism to “flip” through the pages of graphical images, so that the autonomous robot can engage continuous music performance.

A number of the autonomous robots can be grouped and perform together like a band, a chorus, a choir, or even an orchestra, by having each of the autonomous robots playing a specific role from separate sets of graphical image. For example, some may sing as tenors, sopranos, baritones, etc. Similarly, some may play violins and pianos while others play trumpets and drums.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1a is a schematic diagram showing the functional blocks of an autonomous robot according to an embodiment of the present invention.

FIG. 1b is a schematic diagram showing the autonomous robot of FIG. 1a interacting with a display which presents the graphical images.

FIG. 1c is a schematic diagram showing the functional blocks of an autonomous robot according to another embodiment of the present invention.

FIG. 2a is a schematic diagram showing a page of graphical image using numbered notation.

FIG. 2b is a schematic diagram showing the stream of musical information contained in the page of graphical image of FIG. 2a.

FIG. 2c is a schematic diagram showing the stream of musical information runs across two pages of graphical images.

FIG. 2d is a schematic diagram showing multiple steams of musical information run across two pages with special symbols added.

FIG. 2e is a schematic diagram showing multiple steams of musical information in a single page with special symbols added.

FIG. 2f is a schematic diagram showing multiple steams of musical information in a single page with lyrics added.

FIG. 2g is a schematic diagram showing multiple steams of musical information in a single page using two types of symbols to indicate continuation and to specify instrument.

### DETAILED DESCRIPTION OF THE PREFERRED EMBODIMENTS

According to the present invention, an autonomous robot of the present invention is basically a computing device capable of receiving visual triggers in the form of a sequence of graphical image with embedded musical information and delivering audible responses in accordance with the musical information. The autonomous robot itself is not required to have specific shape or body parts; whether it has a humanoid form or whether it has arms or legs or whether it is movable is irrelevant to the present invention.

It should be noted that, even though there are quite a few prior-art robots capable of playing musical instruments (such as the Haile robot) and engaging in trigger-and-response behavior (such as the AIBO robotic dog), the present invention differs from these robots in that, in addition to using synthesis techniques for producing musical sounds of various instruments and human singers, an autonomous robot of the present invention is not pre-programmed to play a specific instrument based on some heuristic algorithm or pre-installed musical information, and the triggers (i.e., graphical images) presented to the robot is not just one-shot commands but contain time-dependent information. However, pointing out these differences is not meant to preclude the possibility that the function of the present invention is integrated with the prior art techniques in a single autonomous robot.

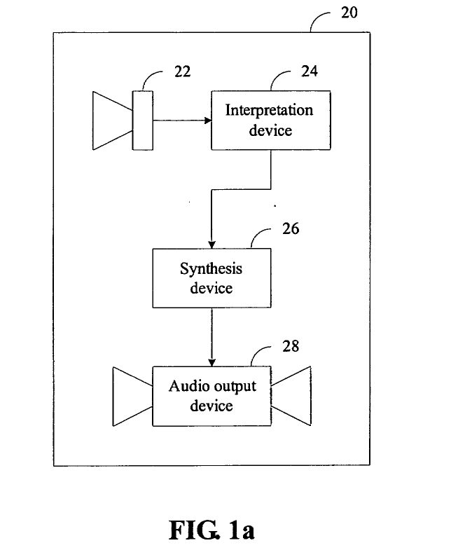

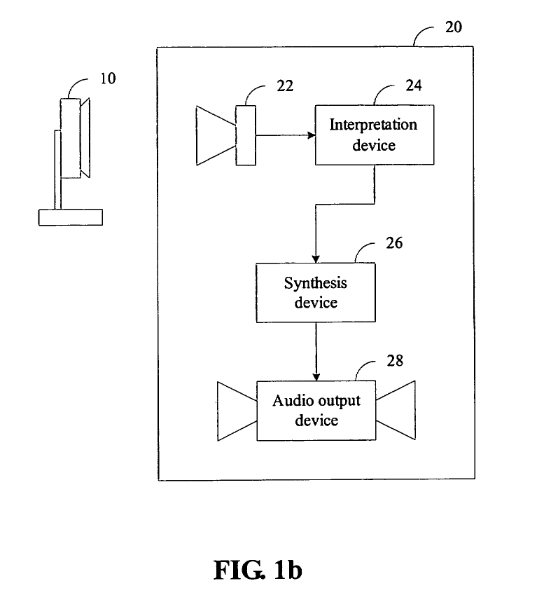

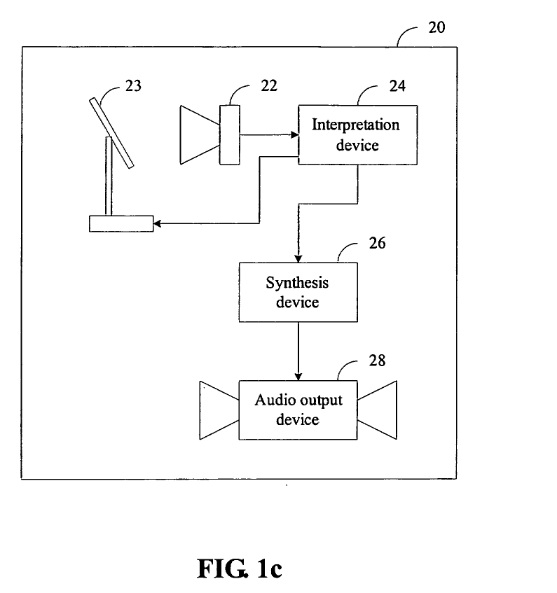

FIG. 1 is a schematic diagram showing the internal functional blocks of an autonomous robot according to the present invention. As illustrated, the autonomous robot mainly contains at least an image capturing device 22 housed in the body 20 of the robot. A typical example of the image capturing device 22 is a CCD camera. Another typical example is a CMOS camera. A one-page-at-a-time, fax-machine-like scanning device is another possible candidate. One additional example is a handheld scanner that can scan strips of graphical images by manually moving the handheld scanner.

Regardless of the technology adopted, the basic characteristic of the image capturing device 22 is that it is capable of obtaining two-dimensional graphical images from external visual triggers. For a fax-machine-like scanning device, a visual trigger is a piece of paper fed through the scanning device. For a handheld scanner, a visual trigger could be a page in a book that the scanner scans. For a camera, a visual trigger could be a frame of a display device (e.g., the panel of a LCD device, the screen of a PDA), a piece of paper, a page in a book, or writings on a white board or a pictorial card. In short, from the image capturing device's point of view, these visual triggers are all two-dimensional graphical images and these two-dimensional graphical images are presented to the autonomous robot and carried in units of “pages.” Here the term “page” is an abstraction of a frame of a display device, a piece of paper, a page in a book, or a card, as described above.

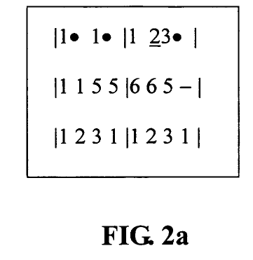

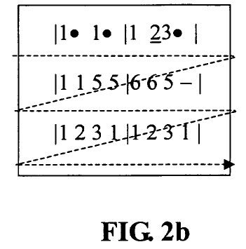

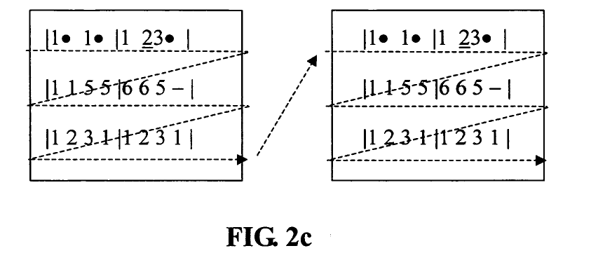

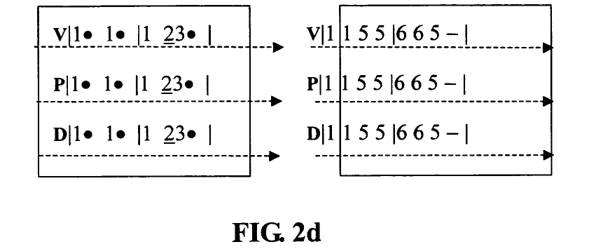

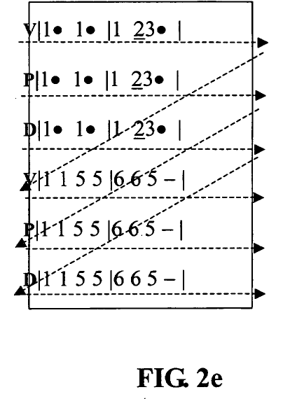

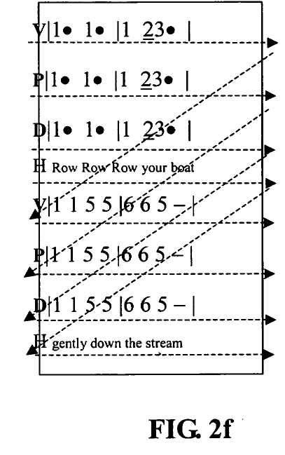

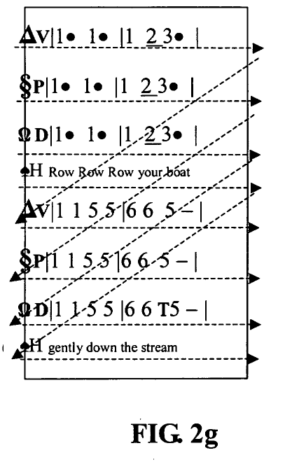

Each page of graphical image contains time-dependent musical information represented by at least a stream (i.e., a linear sequence) of “notes” The “notes” can be the ordinary notes found in the music scores or numbered notations or other symbols that at least indicate the pitch and, among other information, the length of time the pitch must last and, jointly, these “notes” define a melody or rhythm. FIG. 2a is an example of a page of graphical image using numbered notations to deliver the time-dependent musical information of a portion of the famous nursery song “Row, row, row your boat.” As illustrated, the graphical image may contain other special symbols to give more precise definition of the melody. For example, the underscore (“_”) and hyphen (“-”) represent the different lengths of the pitch denoted by the digits, and the dot beneath the digits lowers the pitch to a lower octave. Please note that the numbered notation shown in FIG. 2a is only exemplary and there are many other possible and more sophisticated ways to deliver the time-dependent musical information, whether it is human readable or only machine-recognizable.

As shown in FIG. 1a, the two-dimensional graphical image captured by the image capturing device 22 is passed to an interpretation device 24 for recognition. The interpretation device 24 is the “brain” of the autonomous robot and is usually implemented as a computing device interfacing with the rest of the devices (e.g., the image capturing device 22) via appropriate I/O interfaces. For example, the interpretation device 24 has a conventional computer architecture with CPU, memory, buses, etc., and the image capturing device 22 (e.g., a CCD camera) is connected to the interpretation device 24 via an image capture board installed in an expansion slot of the interpretation device 24. The most significant characteristic of the interpretation device 24 is that it is capable of performing image recognition on the graphical image delivered to it by the image capturing device 22 to extract the time-dependent musical information. Image recognition is a well-know art and many techniques have been disclosed. The subject matter of the present invention is not about the image recognition technique used and any appropriate technique can be used in the present invention.

Please not that the “notes” are arranged in a pre-determined sequence, e.g., from left to right and from top to bottom on the page of graphical image if the page is held in front of the autonomous robot, as denoted by the dotted line shown in FIG. 2b. A very important task of the interpretation device 24 is to decipher the pre-determined sequence of “notes” so that the melody represented by the page of graphical image can be reconstructed. When multiple pages of graphical image are presented to the autonomous robot, in accordance with the sequential order of the pages presented, the melody of each page can be concatenated together into a longer melody by the interpretation device 24, as shown in FIG. 2c. The multiple pages of graphical images can be presented to the autonomous robot in various ways. In one embodiment, each page of graphical image is a pictorial card and the cards are manually shown to the image capturing device 22 one at a time by a person. In another embodiment, the pages of graphical images are pre-installed in a computer or a PDA and the pages are presented on a CRT or LCD display 10 of the computer or the PDA positioned or held in front of the capturing device 22, as shown in FIG. 1b. The presentation of the pages on the display 10 can be automatically controlled by the computer of PDA in a pre-determined speed. In yet another embodiment, an appropriate signal link is provided between the computer or PDA and the interpretation device 24. The switch of pages therefore is controlled by the interpretation device 24 by issuing an appropriate command to the computer of PDA. This can be viewed as some kind of mechanism for “flipping” the pages of graphical image. In one additional embodiment, as shown in FIG. 1c, the “flipping” mechanism 23 can be an integral part of the autonomous robot which holds pieces of paper-based pages of the graphical images and actually flips through the pages under the control of the interpretation device 24. This automatic page flipper is already quite commonly found in advanced scanners specifically designed to automatically produce digital images of a large number of books.

As shown in FIG. 1a, the time-dependent musical information pieced together by the interpretation device 24 from one or more pages of graphical images is concurrently fed to a synthesis device 26 which produces synthesized sound in accordance with the musical information. The synthesized sound is then delivered via the audio output device (e.g., speaker) 28. In one embodiment, the synthesis device 26 is able to simulate multiple types of instrument concurrently. If there is a single stream of musical information, as shown in FIG. 2c, the synthesis device 26 simulates a default type of instrument. For the present embodiment, each page of the graphical image can contain multiple streams of musical information, as shown in FIG. 2d. As illustrated, each page contains three streams of musical information as denoted by the dotted lines with each stream played by the synthesis device 26 simulating a particular type of instrument. To achieve this, special symbols must be positioned at predetermined locations along with the sequences of “notes.” As shown in FIG. 2d, the characters “V,” “P,” and “D” precede each row of notes in a page to specify the corresponding steam of musical information to be played by simulating violin, piano, and drum. As also shown in FIGS. 2d and 2e, the special symbols also allow the interpretation device 24 to recognize and piece together the series of rows of “notes” of the same stream, even when presented with multiple pages of graphical image. Please note that, in another embodiment, there could be multiple synthesis devices 26 with each one simulating a particular of instrument.

As described above, a single autonomous robot according to the present invention is therefore able to simulate a band or an orchestra, or a group of autonomous robots of the present invention can be grouped together and, by configuring each one of them to simulate a particular instrument, play like a band or orchestra. This group of autonomous robots can have separate sets of pages of graphical images respectively, or they can all read from the same set of graphical images. The latter can be achieved by projecting the pages to a spot where each autonomous robot has its image capturing device 22 aimed at.

In another embodiment where the synthesis device 26 is capable of pronouncing words using synthesized voice or pre-recoded alphabets, the autonomous robot can also be triggered to sing along with the melody. As shown in FIG. 2f, which is an extension of FIG. 2e, a stream of lyrics is contained in the graphical image with a special symbol “H” to signal the interpretation device 26 to simulate human voice. Please note that the words of the lyrics have to be aligned with the “notes” appropriately so that the words can be sung harmoniously. Please also note that a stream of words of the lyrics must be associated with a stream of “notes” but a stream of “notes” can be associated with multiple streams of lyrics each preceded with a special symbol for signaling the interpretation device 26 to simulate, for example, a baritone, a tenor, etc, respectively. In other words, the specification of simulating a particular type of human voice is achieved just like specifying a specific type of instrument.

Another simpler way to make the autonomous robot to “sing” is to use phonetic symbols or phonograms to spell the speech sounds of the lyrics, instead of using real words. Other than this, this approach is exactly like the previous embodiment. For example, the phonetic symbols of the lyrics also have to be aligned with the “notes” appropriately so that the phonetic sounds can be produced harmoniously. With the aforementioned approaches, a single autonomous robot can sing a song, play an instrument, or do both at the same time. Additionally, a single autonomous robot or a group of autonomous robots together can sing to simulate the performance by a choir or a chorus.

As shown in FIGS. 2d˜2f, the special symbols are positioned in front of every row of “notes” or lyrics. However, this is not the only possibility. In another embodiment, the special symbols are replaced by two types of symbols: the continuation symbols and the instrument symbols. The continuation symbols are usually positioned in front of every row of “notes” or lyrics, as shown in FIGS. 2d˜2f so that the interpretation device 26 can concatenate the series of rows of the same stream together during its image recognition process. On the other hand, the instrument symbols for specifying the simulation of a particular type of instrument can be embedded in the rows of “notes” or lyrics. FIG. 2g depicts one such example with continuation symbols such as [symbol] , Δ, Ω, §, etc., and instrument symbols such as “V,” “P,” “D,” “H,” etc. An advantage of this embodiment is that, by having the instrument symbols embedded in the streams of musical information such as the “T” (for trumpet) shown in the bottommost “D” row, the autonomous robot is able to dynamically switches instruments during the delivery of a melody. For example, according to bottommost “D” row in FIG. 2g, the autonomous robot will initially simulate, among other types of instruments and human voices, the instrument drum and then subsequently switch to simulate the instrument trumpet.

As shown in FIG. 1a, the output of the synthesis device 26 is fed to, converted into analog signals, and presented as human audible sounds to the surroundings by the audio output device 28. A typical audio output device 28 contains one or more loudspeakers driven by an appropriate amplification circuit. The audio output device 28 can be completely housed inside the body 20 of the autonomous robot or, in some embodiments, the loudspeaker or loudspeakers are placed at a distance from the body 20 and connected to the amplification circuit inside the body 20 by appropriate wired or wireless connection.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An autonomous robot comprising:
an image capturing device capable of obtaining a page of graphical image of a visual trigger presented to said image capturing device, said page of graphical image containing at least a stream of symbols;
an interpretation device capable of recognizing said stream of symbols and extracting time-dependent musical information from said stream of symbols, said time-dependent musical information containing at least a sequence of pitches and the length of time of each pitch;
a synthesis device generating an output signal by simulating a sound source delivering said time-dependent musical information; and
an audio output device having a loudspeaker converting said output signal into human audible sounds.

2. The autonomous robot according to claim 1, wherein said image capturing device is one of a camera and a scanner.

3. The autonomous robot according to claim 1, wherein said page is one of a frame of a display device, a piece of paper, a card, and a book page.

4. The autonomous robot according to claim 1, wherein said symbols contains music notes.

5. The autonomous robot according to claim 1, wherein said symbols contains numbered notations.

6. The autonomous robot according to claim 1, wherein said symbols contains a special symbol indicating a specific type of instrument as said sound source.

7. The autonomous robot according to claim 1, wherein said page of graphical image further contains a stream of words or phonograms aligned appropriately with said stream of symbols.

8. The autonomous robot according to claim 7, wherein said symbols contains a special symbol indicating a specific type of human voice as said sound source.

9. The autonomous robot according to claim 1, wherein said stream of symbols is arranged in a plurality of rows on said page; and each row of symbols contains a special symbol indicating the concatenation of said rows into said stream of symbols.

10. The autonomous robot according to claim 9, wherein said special symbol also indicates a specific type of instrument as said sound source.

11. The autonomous robot according to claim 7, wherein said stream of words or phonograms is arranged in a plurality of rows on said page; and each row of words or phonograms contains a special symbol indicating the concatenation of said rows into said stream of words.

12. The autonomous robot according to claim 11, wherein said special symbol also indicates a specific type of human voice as said sound source.

13. The autonomous robot according to claim 1, further comprising a flipping means presenting a sequence of said pages to said image capturing device.

14. The autonomous robot according to claim 13, wherein said flipping means contains a signal link between said interpretation device and a physical device having said sequence of said pages; and said interpretation device triggers said physical device via said signal link to present a page.

15. A method for autonomous music playing comprising the steps of:
obtaining a page of graphical image containing a stream of symbols;
recognizing said stream of symbols and extracting time-dependent musical information from said stream of symbols, said time-dependent musical information containing at least a sequence of pitches and the length of time of each pitch;
generating an output signal by simulating a sound source delivering said time-dependent musical information; and
converting said output signal into human audible sounds.

16. The method according to claim 15, wherein said page is one of a frame of a display device, a piece of paper, a card, and a book page.

17. The method according to claim 15, wherein said symbols contains music notes.

18. The method according to claim 15, wherein said symbols contains numbered notations.

19. The method according to claim 15, wherein said symbols contains a special symbol indicating a specific type of instrument as said sound source.

20. The method according to claim 15, wherein said page of graphical image further contains a stream of words or phonograms aligned appropriately with said stream of symbols.

21. The autonomous robot according to claim 20, wherein said symbols contains a special symbol indicating a specific type of human voice as said sound source.

22. The autonomous robot according to claim 15, wherein said stream of symbols is arranged in a plurality of rows on said page; and each row of symbols contains a special symbol indicating the concatenation of said rows into said stream of symbols.

23. The autonomous robot according to claim 22, wherein said special symbol also indicates a specific type of instrument as said sound source.

24. The autonomous robot according to claim 20, wherein said stream of words or phonograms is arranged in a plurality of rows on said page; and each row of words or phonograms contains a special symbol indicating the concatenation of said rows into said stream of words or phonograms.

25. The autonomous robot according to claim 24, wherein said special symbol also indicates a specific type of human voice as said sound source.
